(19) United States
(12) Patent Application Publication
(10) Pub. No.: US 2023/0058771 A1
(43) Pub. Date: Feb. 23, 2023

(54) SELF-PROPELLED FOOD DELIVERY PALLET

(71) Applicant: TOYOTA JIDOSHA KABUSHIKI KAISHA, Aichi-ken (JP)

(72) Inventors: Tetsuya KANATA, Toyota-shi (JP); Tomoko ASAI, Nagoya-shi (JP); Kohki BABA, Susono-shi (JP); Kei SATO, Toyota-shi (JP); Takashi HAYASHI, Nagoya-shi (JP); Manabu NAGAI, Nagoya-shi (JP)

(21) Appl. No.: 17/864,398

(22) Filed: Jul. 14, 2022

(30) Foreign Application Priority Data
Aug. 17, 2021 (JP) 2021-132998

(51) Int. Cl. F24C 1/16; G08B 21/18; A47J 36/24; A47J 47/14

(52) U.S. Cl. CPC F24C 1/16; G08B 21/18; A47J 36/24; A47J 47/14

(57) ABSTRACT

A food delivery pallet is provided with a heating chamber, a heat retaining chamber, a heat retaining chamber, a cooling chamber, and an electric bulletin board. Therefore, in the food delivery pallet, when food is heated in the heating chamber, the electric bulletin board displays that the food is being heated in the food delivery pallet. This makes it possible to call attention of people nearby to the food delivery pallet, and to ensure safety of the people nearby.

### CROSS-REFERENCE TO RELATED APPLICATION

This application claims priority to Japanese Patent Application No. 2021-132998 filed on Aug. 17, 2021, incorporated herein by reference in its entirety.

### BACKGROUND

### 1. Technical Field

The present disclosure relates to a self-propelled food delivery pallet.

### 2. Description of Related Art

Japanese Unexamined Patent Application Publication No. 6-305357 (JP 6-305357 A) discloses a technique relating to a cooking vehicle including a cooker using a combustor. In this related art, the air intake/exhaust port of the combustor inside the body of a closed-type cooking vehicle that is sealed and used during cooking is directly communicated to the outside of the vehicle body without going through the operation room inside the vehicle body, so that the high-temperature combustion air generated by the heat of the combustor is exhausted to the outside of the vehicle body without going through the operation room inside the vehicle body. Accordingly, the ventilation inside the vehicle body can be adjusted and the room temperature can be adjusted to an appropriate temperature.

### SUMMARY

Since the above-mentioned related art assumes that a cook operates inside the vehicle body, it is necessary to improve the environment inside the vehicle body as described above. However, for example, when considering unmanned delivery services such as food delivery, it is necessary to ensure safety for people near the traveling vehicle body.

In view of the above facts, an object of the present disclosure is to provide a self-propelled food delivery pallet capable of ensuring safety for people nearby.

A self-propelled food delivery pallet according to claim 1 is able to travel by itself between a supply base at which food is supplied and a receiving base at which the food is received, and includes: a food keeping unit provided in a food delivery pallet main body and provided with an arrangement place in accordance with a keeping state of the food to be delivered; and a warning unit that is provided on an outside of the food delivery pallet main body and that calls attention of an outside to the food delivery pallet main body.

The self-propelled food delivery pallet according to claim 1 is able to travel by itself between the supply base at which the food is supplied and the receiving base at which the food is received, and includes the food keeping unit and the warning unit. The food keeping unit is provided in the food delivery pallet main body, and the arrangement place is provided in accordance with the keeping state of the food. The warning unit is provided on the outside of the food delivery pallet main body and calls attention of the outside to the food delivery pallet main body.

Here, “in accordance with the keeping state of the food” includes, for example, when keeping the food, in addition to keeping the food at room temperature, cases of cooling, freezing, retaining the heat, heating, and the like. Therefore, regarding the arrangement place in accordance with the keeping state of the food, for example, the food to be cooled is arranged in the cooling chamber, the food to be kept warm is arranged in the heat retaining chamber, and the food to be heated is arranged in the heating chamber.

The warning unit calls attention of the people (of the outside) near the self-propelled food delivery pallet (the food delivery pallet main body) to the self-propelled food delivery pallet. Therefore, for example, when the food is heated, the warning unit displays or notifies that the food is being heated in the food delivery pallet main body, which makes it possible to call attention of the people nearby to the self-propelled food delivery pallet.

In the self-propelled food delivery pallet according to claim 2, in the self-propelled food delivery pallet according to claim 1, the warning unit includes a display unit that displays a precaution for the food delivery pallet main body.

The self-propelled food delivery pallet according to claim 2 includes, as the warning unit, the display unit for displaying a precaution for the food delivery pallet main body, and the display unit displaying the precaution calls attention of the people near the self-propelled food delivery pallet.

In the self-propelled food delivery pallet according to claim 3, in the self-propelled food delivery pallet according to claim 1 or 2, the warning unit includes a notification unit that notifies a precaution for the food delivery pallet main body.

The self-propelled food delivery pallet according to claim 3 includes, as the warning unit, the notification unit for notifying a precaution for the food delivery pallet main body, and the notification unit notifying the precaution by voice or the like calls attention of the people near the self-propelled food delivery pallet.

In the self-propelled food delivery pallet according to claim 4, in the self-propelled food delivery pallet according to any one of claims 1 to 3, when the warning unit calls attention of the outside to the food delivery pallet main body, a distance between the food delivery pallet main body and people nearby is set to be larger than usual.

In the self-propelled food delivery pallet according to claim 4, when the warning unit calls attention of the outside to the food delivery pallet main body, the distance between the self-propelled food delivery pallet and the people near the self-propelled food delivery pallet is set to be larger than usual. Here, “usual” means a state in which it is not necessary to call attention of the outside to the food delivery pallet main body.

In the self-propelled food delivery pallet according to claim 5, in the self-propelled food delivery pallet according to any one of claims 1 to 4, the food keeping unit includes at least one of a heat retaining chamber for keeping the food warm and a cooling chamber for cooling the food.

The self-propelled food delivery pallet according to claim 5 includes, as the food keeping unit, at least one of the heat retaining chamber for keeping the food warm and the cooling chamber for cooling the food. When the self-propelled food delivery pallet is provided with a heat retaining chamber, the food to be kept warm is kept in the heat retaining chamber. When the self-propelled food delivery pallet is provided with a cooling chamber, the food to be cooled is kept in the cooling chamber.

In the self-propelled food delivery pallet according to claim 6, in the self-propelled food delivery pallet according to any one of claims 1 to 5, the food keeping unit includes a heating chamber for heating the food.

The self-propelled food delivery pallet according to claim 6 includes, as the food keeping unit, the heating chamber for heating the food, and the food can be heated in the heating chamber. Therefore, the food can be heated while the self-propelled food delivery pallet travels by itself from the supply base at which the food is supplied to the receiving base at which the food is received.

As described above, the self-propelled food delivery pallet according to claim 1 has an excellent effect that safety of the people nearby can be ensured.

The self-propelled food delivery pallet according to claim 2 has an excellent effect that attention of the people nearby can be called by displaying the precaution.

The self-propelled food delivery pallet according to claim 3 has an excellent effect that attention of the people nearby can be called by notifying the precaution.

The self-propelled food delivery pallet according to claim 4 has an excellent effect that safety of the people nearby can be ensured by increasing the distance from the people nearby.

The self-propelled food delivery pallet according to claim 5 has an excellent effect that the food can be kept in accordance with the keeping state of the food to be delivered.

The self-propelled food delivery pallet according to claim 6 can heat the food while delivering the food to the receiving base, and thus has an excellent effect that it is possible to save the time by performing the heating and cooking, which is normally performed at the supply base, while traveling by itself.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing a configuration of a delivery system using a self-propelled food delivery pallet according to a present embodiment;

FIG. 2 is a perspective view showing the self-propelled food delivery pallet according to the present embodiment;

FIG. 3 is a side sectional view showing the self-propelled food delivery pallet according to the present embodiment;

FIG. 4 is a plan view when cut along the line A-A of FIG. 3;

FIG. 5 is a block diagram showing a hardware configuration of a server of a store that constitutes a part of the delivery system according to the present embodiment;

FIG. 6 is a block diagram showing a functional configuration of the server that constitutes the delivery system according to the present embodiment;

FIG. 7 is a block diagram showing a hardware configuration of the self-propelled food delivery pallet that constitutes a part of the delivery system according to the present embodiment;

FIG. 8 is a block diagram showing a functional configuration of the self-propelled food delivery pallet that constitutes the delivery system according to the present embodiment;

FIG. 9 is a block diagram showing a hardware configuration of a user terminal that constitutes a part of the delivery system according to the present embodiment; and

FIG. 10 is a block diagram showing a functional configuration of the user terminal that constitutes the delivery system according to the present embodiment.

### DETAILED DESCRIPTION OF EMBODIMENTS

A self-propelled food delivery pallet according to an embodiment of the present disclosure will be described with reference to the drawings.

Outline

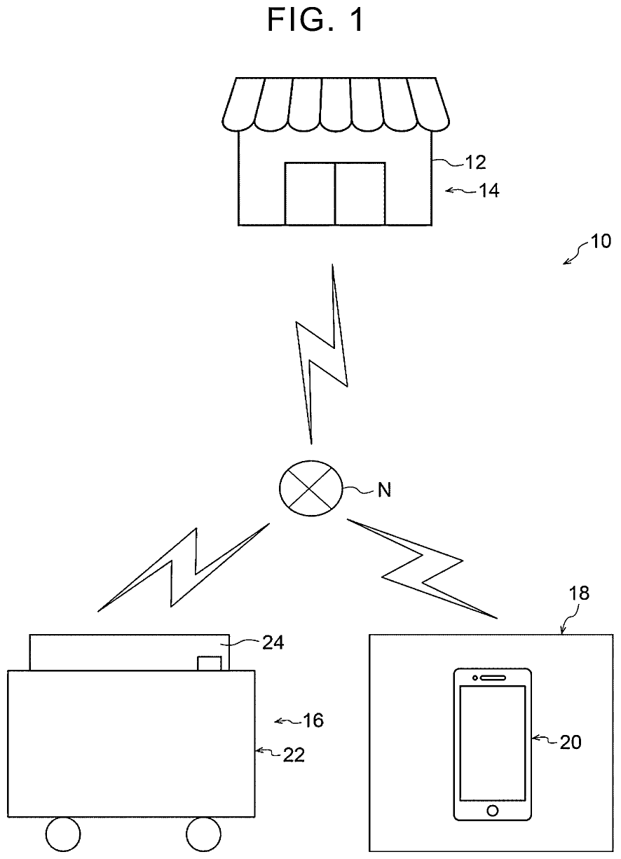

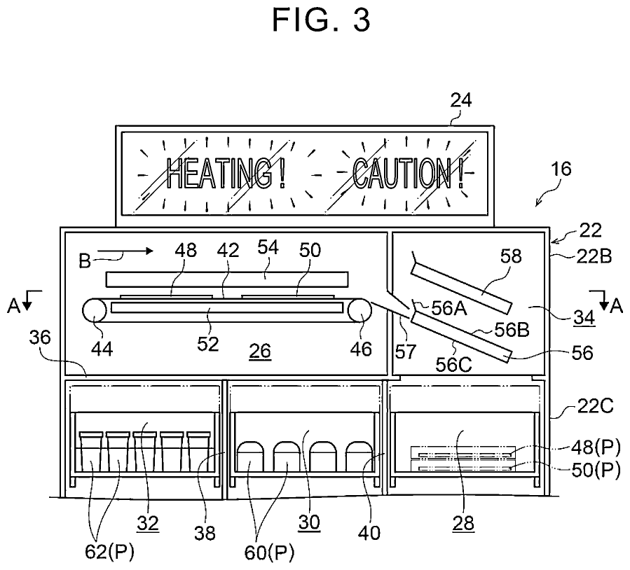

As shown in FIG. 1, a delivery system 10 includes, for example, a server 14 of a store 12 that serves as a supply base for supplying food P to be delivered (see FIG. 3), and a self-propelled food delivery pallet 16 where the food P to be delivered is accommodated, and a terminal (user terminal) 20 of a user at a user's home 18 serving as a receiving base for receiving the food P. The server 14, the food delivery pallet 16, and the user terminal 20 can communicate with each other via a network N.

The delivery system 10 provides, for example, a service in which the food P designated by the user is accommodated in the food delivery pallet 16 and delivered to the delivery destination designated by the user. The food delivery pallet 16 can travel by itself between the store 12 at which the food P is supplied and the user's home 18 at which the food P is received. Although the user who purchases the product and the recipient who receives the product may be different, in the present embodiment, for convenience of explanation, the case where the user and the recipient are the same will be described.

Configuration of Self-Propelled Food Delivery Pallet

First, the configuration of the self-propelled food delivery pallet according to the present embodiment will be described.

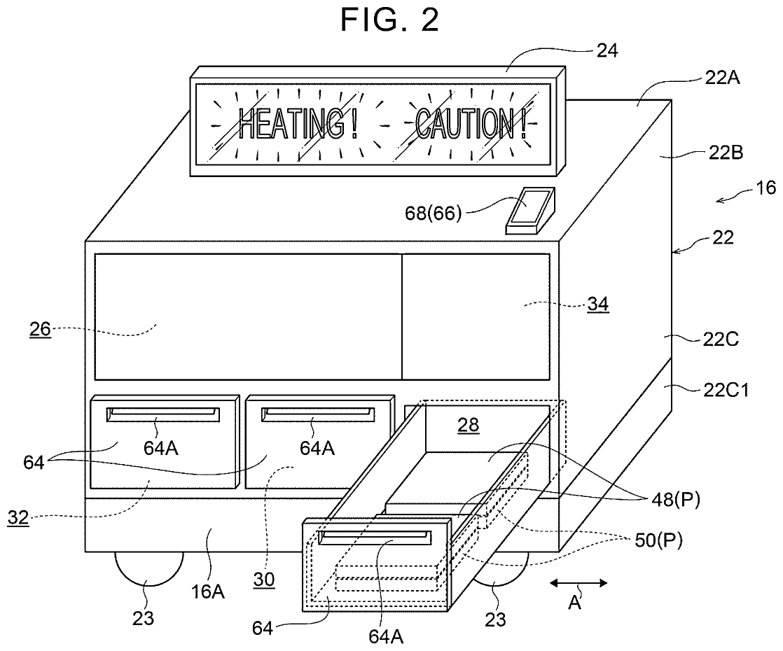

As shown in FIG. 2, the food delivery pallet 16 includes a box-shaped food delivery pallet main body 22. A plurality of wheels 23 is provided on the lower side of the food delivery pallet main body 22 to enable the food delivery pallet 16 to travel.

On an upper surface (outside) 22A of the food delivery pallet main body 22, for example, an electric bulletin board (display unit) 24 as a warning unit is provided. The electric bulletin board 24 is provided in an upright state with respect to the upper surface 22A of the food delivery pallet main body 22, and is disposed along the longitudinal direction (arrow A direction) of the food delivery pallet main body 22. For example, warnings such as “Heating! Caution!” are displayed on the electric bulletin board 24. In addition to this, the warnings are appropriately selected according to the content to be noted, such as hot, cracked objects, heavy objects, and during cooking. It should be noted that the display unit does not necessarily have to be the electric bulletin board 24 as long as the warnings are noticeable.

Further, as shown in FIG. 3, the food delivery pallet 16 includes, in the food delivery pallet main body 22, a heating chamber 26, a heat retaining chamber 28, a heat retaining chamber 30, and a cooling chamber 32, as a food keeping unit. A packing chamber 34 is provided next to the heating chamber 26. The heating chamber 26 and the packing chamber 34 are provided on an upper portion 22B side of the food delivery pallet main body 22, and the heat retaining chambers 28, 30 and the cooling chamber 32 are provided on a lower portion 22C side of the food delivery pallet main body 22. A battery (not shown) is provided at a lower end portion 22C1 (see FIG. 2) of the food delivery pallet main body 22, and electric power is supplied from this battery. In FIG. 3, the lower end portion 22C1 of the food delivery pallet main body 22 is not shown.

Here, the food delivery pallet 16 may be configured to be capable of wireless power supply that enables supplying power in a non-contact manner. When traveling on a road surface in which a power transmission coil is embedded, a power feeding coil may be provided on the food delivery pallet 16, and current may be passed through the power transmission coil to supply electric power to the power feeding coil of the food delivery pallet 16. Accordingly, the food delivery pallet 16 can be supplied with electric power while traveling.

A part of the upper portion 22B of the food delivery pallet main body 22 and a part of the lower portion 22C of the food delivery pallet main body 22 are partitioned by a partition wall 36 with a heat insulating effect, which constitutes a structure in which heat transfer is not performed between the part of the upper portion 22B and the part of the lower portion 22C of the food delivery pallet main body 22. Further, a partition wall 38 is provided between the cooling chamber 32 and the heat retaining chamber 30, and a partition wall 40 is provided between the heat retaining chamber 28 and the heat retaining chamber 30. Similar to the partition wall 36, the partition wall 38 has a heat insulating effect, which constitutes a structure in which heat transfer is not performed between the cooling chamber 32 and the heat retaining chamber 30. However, the partition wall 40 does not necessarily require a heat insulating effect, and the heat of the heat retaining chamber 28 may be transferable to the heat retaining chamber 30.

As described above, the heating chamber 26 is provided on the upper portion 22B of the food delivery pallet main body 22. A lid portion (not shown) is provided on the upper portion of the food delivery pallet main body 22 so as to be openable and closable. With the lid portion open, the heating chamber 26 can be exposed. The lid portion can be opened and closed only by the store 12.

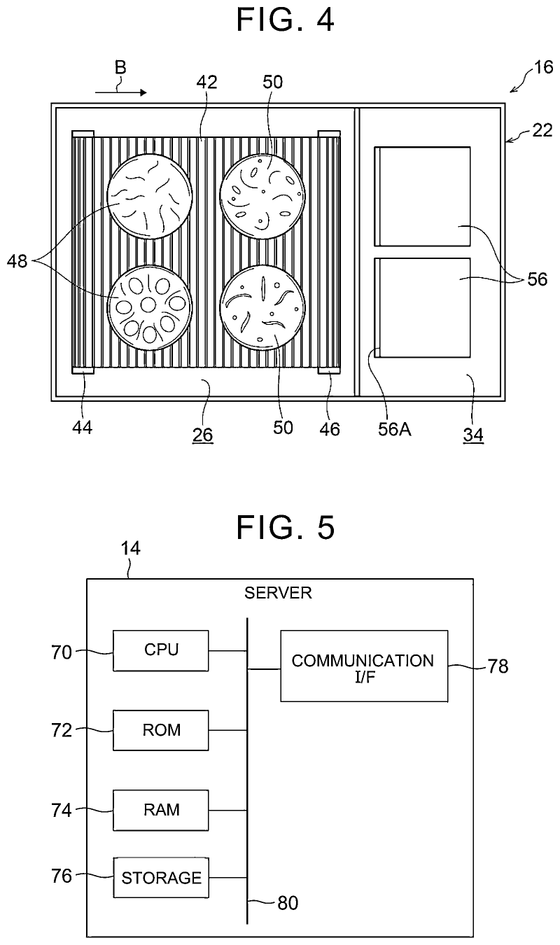

As shown in FIGS. 3 and 4, a stainless steel endless transport belt 42 is provided substantially horizontally in the heating chamber 26. A plurality of (four in this case) large-sized pizzas 48, 50 can be placed on the transport belt 42, and the size of the transport belt 42 is set according to the number of pizzas 48, 50 that can be placed. Rollers 44, 46 are arranged on both ends of the transport belt 42 in the longitudinal direction (arrow B direction), with the width direction orthogonal to the longitudinal direction of the transport belt 42 serving as the axial direction. The transport belt 42 is wound around the rollers 44, 46.

A heater 52 is provided inside the transport belt 42, and the heater 52 heats the lower surface sides of the pizzas 48, 50. Further, with the lid portion of the food delivery pallet main body 22 closed, a heater 54 is set to be disposed above the transport belt 42, and the heater 54 heats the upper surface sides of the pizzas 48, 50. That is, in the heating chamber 26, the pizzas 48, 50 can be heated and cooked. Therefore, the pizzas 48, 50 before being heated can be placed on the transport belt 42.

When the heating of the pizzas 48, 50 is completed, the rollers 44, 46 rotate at a constant angle. Accordingly, of the pizzas 48, 50 placed on the transport belt 42, the pizzas 50 placed on the roller 46 side drop from the transport belt 42, and are guided to the packing chamber 34 provided next to the heating chamber 26. Decorative boxes 56 are arranged on the downstream side in the transport direction (arrow B direction) of the pizzas 48, 50, that is, in the packing chamber 34, and are set so that the pizzas 50 that have dropped from the transport belt 42 are accommodated in the decorative boxes 56.

For example, a guide plate 57 is disposed on the downstream side in the transport direction of the pizzas 48, 50, and the decorative boxes 56 are arranged further on the downstream side of the guide plate 57. The guide plate 57 and the decorative boxes 56 are arranged so as to be inclined downward in a direction away from the transport belt 42, and the pizzas 50 that have dropped from the transport belt 42 slide down the guide plate 57 so as to be accommodated in the decorative boxes 56.

An opening (not shown) is thus provided on a side wall 56A side of the decorative box 56, and the pizza 50 is accommodated in the decorative box 56 through the opening. The side wall 56A of the decorative box 56 is bent upward, and when the pizza 50 is accommodated in the decorative box 56, the side wall 56A is bent downward to close the opening. In this way, the decorative box 56 with the closed opening drops downward to be placed in the heat retaining chamber 28.

Although not shown, new decorative boxes 58 are arranged on the upper portion of the packing chamber 34, and when the decorative boxes 56 drop, the decorative boxes 58 are moved downward. When the new decorative boxes 58 are arranged on the downstream side in the transport direction of the pizzas 48, 50, the rollers 44, 46 further rotate. Accordingly, the pizzas 48 remaining on the transport belt 42 drop from the transport belt 42 to be accommodated in the decorative boxes 58. When the openings of the decorative boxes 58 are closed, the decorative boxes 58 drop downward and are placed in the heat retaining chamber 28 so as to be stacked on the decorative boxes 56 from above.

As described above, the pizzas 48, 50 heated and cooked in the heating chamber 26 are each packed in the decorative boxes 56, 58, and arranged in the heat retaining chamber 28.

In the present embodiment, as described above, the opening is provided on the side wall 56A side of the decorative box 56. However, it is only necessary that the heated and cooked pizza 50 can be packed in the decorative box 56, so that the packing method is not limited to this, and it goes without saying that the pizza 50 may be packed from the upper side of the decorative box 56. However, in that case, as compared with the above embodiment, it is necessary to increase the space in the packing chamber 34 along the longitudinal direction (arrow B direction) of the transport belt 42.

As described above, the lower portion 22C of the food delivery pallet main body 22 is provided with the heat retaining chamber 28, the heat retaining chamber 30, and the cooling chamber 32 for keeping the food P to be delivered. As shown in FIG. 2, a drawer-type tray 64 is provided in each of the heat retaining chambers 28, 30 and the cooling chamber 32, and the drawer-type trays 64 can be pulled out from a front surface 16A side of the food delivery pallet 16 toward the front.

The drawer-type tray 64 is provided with a drawer recess 64A along a substantially horizontal direction. A finger can be hooked in the drawer recess 64A. By hooking the finger in the drawer recess 64A, the drawer-type tray 64 is pulled toward the front using the drawer recess 64A, so that the food in the heat retaining chambers 28, 30 and the cooling chamber 32 can be taken out.

As the food P to be delivered, the pizzas 48 and the pizzas 50 are accommodated (kept) in the heat retaining chamber 28, and heat-retained food 60 other than the pizzas 48, 50 such as pasta, chicken, and potatoes is accommodated (kept) in the heat retaining chamber 30. Further, cooled food 62 to be cooled, such as salads and beverages is accommodated (kept) in the cooling chamber 32.

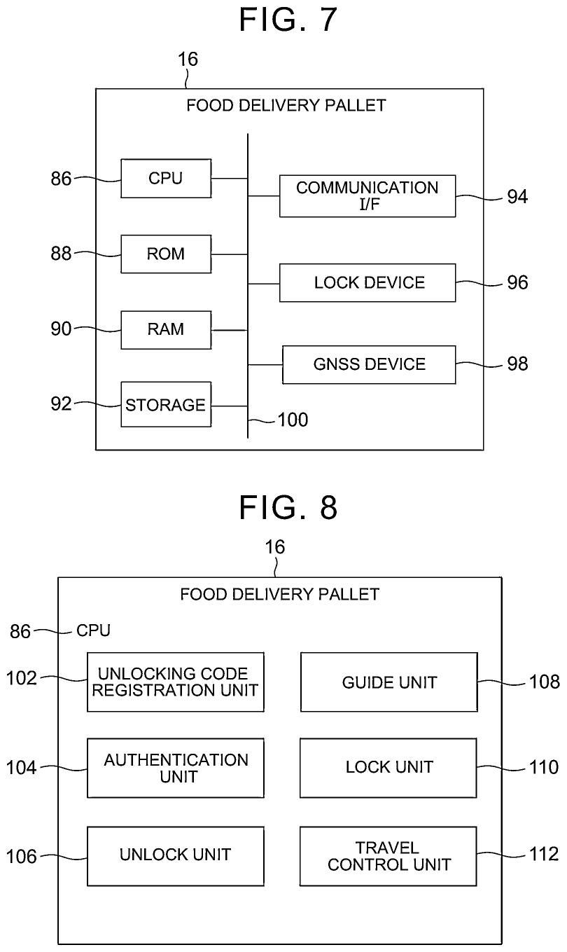

On the upper surface 22A of the food delivery pallet main body 22, for example, a code reading unit 68 for unlocking a lock device 96 (see FIG. 7) using an electronic lock (not shown), which will be described later, is provided. The code reading unit 68 is configured to be able to read the unlocking code of the lock device 96 presented by the user. The unlocking code is, for example, a two-dimensional code displayed on a display screen of the user terminal 20 (see FIG. 1). The two-dimensional code is unique information that is coded, and is a bar code, a QR code (registered trademark), or the like.

Configuration of Delivery System

Here, the server 14 of the store 12, the food delivery pallet 16, and the user terminal 20 that constitute the delivery system 10 using the food delivery pallet 16 will be described in order.

Hardware Configuration of Server

The hardware configuration included in the server 14 will be described with reference to FIG. 5. The server 14 includes a central processing unit (CPU) 70, a read-only memory (ROM) 72, a random access memory (RAM) 74, a storage 76, and a communication interface (I/F) 78. The CPU 70, the ROM 72, the RAM 74, and the communication I/F 78 are connected to each other so as to be communicable with each other via a bus 80.

The CPU 70 as a control unit is a central processing unit that executes various programs and that controls various units. In other words, the CPU 70 reads the program from the ROM 72 or the storage 76 and executes the program using the RAM 74 as a work area.

The CPU 70 controls each of the above configurations and executes various arithmetic processes in accordance with the program recorded in the ROM 72 or the storage 76. The ROM 72 stores various programs and various data. The RAM 74 temporarily stores a program or data as a work area. The storage 76 as a storage unit is configured by a hard disk drive (HDD) or a solid state drive (SSD), and stores various programs including an operating system and various data. In the present embodiment, the storage 76 stores the ID of the user (recipient) of the food P, the delivery destination address, the user's contact email address, the desired delivery date and time, and the like.

The communication I/F 78 is an interface for communicating with other devices such as the food delivery pallet 16 and the user terminal 20 shown in FIG. 1, and communication standards such as Ethernet (registered trademark), long-term evolution (LTE), fiber-distributed data interface (FDDI), and Wi-Fi (registered trademark) are used.

Functional Configuration of Server

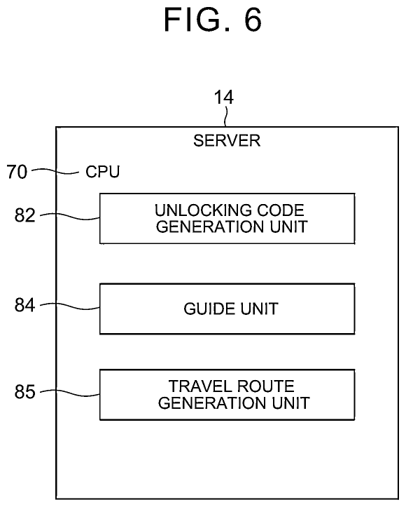

Next, an example of the functional configuration of the CPU 70 will be described. As shown in FIG. 6, the CPU 70 includes an unlocking code generation unit 82, a guide unit 84, and a travel route generation unit 85. Each functional configuration is realized as the CPU 70 shown in FIG. 5 reads and executes the execution program stored in the ROM 72 or the storage 76.

The unlocking code generation unit 82 generates an unlocking code such as a barcode or a QR code (registered trademark) to unlock the lock device 96 (see FIG. 7) for the drawer-type trays 64 of the heat retaining chambers 28, 30 and the cooling chamber 32 provided on the food delivery pallet 16.

The guide unit 84 guides the generated unlocking code to the food delivery pallet 16 and the user terminal 20 shown in FIG. 1. Specifically, the guide unit 84 acquires information such as the ID of the user who receives the food P (see FIG. 3) and the contact email address of the user in association with each other, and guides the generated unlocking code to the food delivery pallet 16 and the user terminal 20 via the communication I/F 78.

When the guide unit 84 receives the unlocking information indicating that the food delivery pallet 16 has been unlocked, the guide unit 84 informs the user terminal 20 via the communication I/F 78 that the food delivery pallet 16 has been unlocked. Further, when the guide unit 84 receives the locking information indicating that the food delivery pallet 16 has been locked, the guide unit 84 informs the user terminal 20 via the communication I/F 78 that the food delivery pallet 16 has been locked.

The travel route generation unit 85 generates a travel route based on the map information, and the food delivery pallet 16 travels according to the travel route generated by the travel route generation unit 85.

Hardware Configuration of Food Delivery Pallet

The hardware configuration included in the food delivery pallet 16 will be described with reference to FIG. 7. The food delivery pallet 16 includes a CPU 86, a ROM 88, a RAM 90, a storage 92, a communication I/F 94, a lock device 96, and a global navigation satellite system (GNSS) device 98. Each configuration is communicably connected to each other via a bus 100.

The CPU 86 as a control unit is a central arithmetic processing unit, and reads a program from the ROM 88 or the storage 92 to execute the program using the RAM 90 as a work area.

The ROM 88 stores various programs and various data. The RAM 90 temporarily stores a program or data as a work area. The storage 92 is composed of an HDD, an SSD, or a flash memory, and stores various programs including an operating system and various data.

The communication I/F 94 is an interface for communicating with other devices such as the server 14 and the user terminal 20 shown in FIG. 1, and standards such as Ethernet (registered trademark), FDDI, and Wi-Fi (registered trademark) are used.

The lock device 96 is composed of an electronic lock, and can lock and unlock the drawer-type trays 64 of the heat retaining chambers 28, 30 and the cooling chamber 32 provided in the food delivery pallet 16 shown in FIG. 2, for example, by a lock mechanism (not shown) using a solenoid or the like. The lock device 96 can also read the unlocking code using the code reading unit 68 that constitutes a part of the lock device 96.

The GNSS device 98 acquires the current position of the food delivery pallet 16.

Functional Configuration of Self-Propelled Food Delivery Pallet

Next, an example of the functional configuration of the CPU 86 will be described. As shown in FIG. 8, the CPU 86 includes an unlocking code registration unit 102, an authentication unit 104, an unlock unit 106, a guide unit 108, a lock unit 110, and a travel control unit 112. Each functional configuration is realized as the CPU 86 shown in FIG. 7 reads and executes the execution program stored in the ROM 88 or the storage 92.

The unlocking code registration unit 102 registers (stores) the unlocking code, which has been notified from the server 14, in the ROM 88 or the storage 92.

The authentication unit 104 performs an authentication operation as to whether the unlocking code presented by the user matches the unlocking code registered in the ROM 88 or the storage 92. Specifically, when the code reading unit 68 of the lock device 96 reads the two-dimensional code, the authentication unit 104 performs an authentication operation as to whether the two-dimensional code (unlocking code presented by the user) read by the code reading unit 68 matches the registered unlocking code.

When the authentication unit 104 confirms that the unlocking code presented by the user matches the unlocking code registered in the ROM 88 or the storage 92, the unlock unit 106 unlocks the drawer-type tray 64 (electronic lock) of the heat retaining chamber 28, 30 or the cooling chamber 32 shown in FIG. 2, in which the food P to be received by the user (see FIG. 2) is accommodated.

When the drawer-type tray 64 of the heat retaining chamber 28, 30 or the cooling chamber 32 is unlocked by using the unlocking code, the guide unit 108 notifies the server 14 via the communication I/F 122 that the drawer-type tray 64 has been unlocked.

The lock unit 110 locks the electronic lock when the drawer-type tray 64 of the heat retaining chamber 28, 30 or the cooling chamber 32 is closed.

When the drawer-type tray 64 of the heat retaining chamber 28, 30 or the cooling chamber 32 is locked, the guide unit 108 notifies the server 14 and the user terminal 20 via the communication I/F 94 that the drawer-type tray 64 has been locked.

The guide unit 108 notifies the server 14 of the position information of the food delivery pallet 16 acquired by the GNSS device 98. Further, when the food delivery pallet 16 becomes incapable of traveling, such as when the food delivery pallet 16 falls sideways or the food delivery pallet 16 is damaged due to theft, the guide unit 108 notifies the server 14 that the food delivery pallet 16 is incapable of traveling.

The travel control unit 112 causes the food delivery pallet 16 to travel according to the travel route generated by the travel route generation unit 85. In the food delivery pallet 16, when the drawer-type trays 64 of the heat retaining chambers 28, 30 and the cooling chamber 32 are locked, the food delivery pallet 16 is allowed travel, and when the drawer-type trays 64 are not locked, the food delivery pallet 16 does not travel.

Further, as a condition for traveling, in the present embodiment, when the user completes the receiving procedure for receiving the food or when reception of all the food scheduled to be received by the user is completed, the food delivery pallet 16 is allowed to travel. Therefore, when the user's receiving procedure is not completed, or when reception of all the food by the user is not completed, the food delivery pallet 16 does not travel.

Hardware Configuration of User Terminal

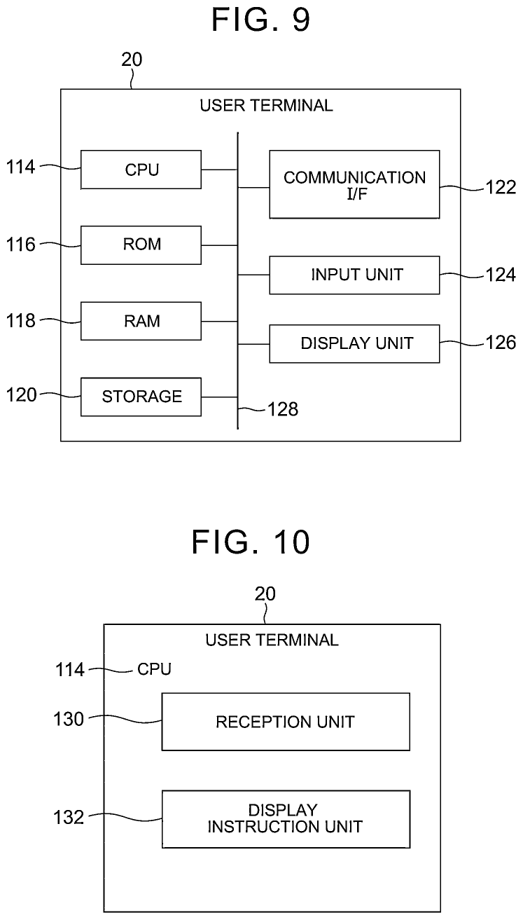

The hardware configuration included in the user terminal 20 will be described with reference to FIG. 9. The user terminal 20 includes a CPU 114, a ROM 116, a RAM 118, a storage 120, a communication I/F 122, an input unit 124, and a display unit 126. Each configuration is communicably connected to each other via a bus 128.

The CPU 114 as a control unit is a central arithmetic processing unit, and reads a program from the ROM 116 or the storage 120 to execute the program using the RAM 118 as a work area.

The ROM 116 stores various programs and various data. The RAM 118 temporarily stores a program or data as a work area. The storage 120 is composed of an HDD, an SSD, or a flash memory, and stores various programs including an operating system and various data.

The communication I/F 122 is an interface for communicating with other devices such as the server 14 and the food delivery pallet 16 shown in FIG. 1, and standards such as Ethernet (registered trademark), FDDI, and Wi-Fi (registered trademark) are used.

The input unit 124 receives an operation input by the user. The input unit 124 includes, for example, a keyboard, a touch panel, a microphone, a camera, or the like. The display unit 126 displays information and the like on the screen.

The display unit 126 is, for example, a display. The input unit 124 and the display unit 126 may be integrated as a touch panel.

A general-purpose smartphone, a tablet terminal, or the like can be used as the user terminal 20.

Functional Configuration of User Terminal

Next, an example of the functional configuration of the CPU 114 will be described. As shown in FIG. 10, the CPU 114 includes a reception unit 130 and a display instruction unit 132. Each functional configuration is realized as the CPU 114 shown in FIG. 7 reads and executes the execution program stored in the ROM 116 or the storage 120.

The reception unit 130 receives a notification of the unlocking code transmitted from the server 14.

Further, when the reception unit 130 receives the notification indicating that the drawer-type tray 64 of the heat retaining chamber 28, 30 or the cooling chamber 32 has been unlocked, the reception unit 130 receives, in the user terminal 20 of the user who is the recipient of the food P, a notification indicating that the drawer-type tray 64 has been unlocked.

When the reception unit 130 receives the notification indicating that the drawer-type tray 64 has been locked, the reception unit 130 receives, in the user terminal 20, the notification indicating that the drawer-type tray 64 has been locked. This is a so-called reception-confirmation notification.

The display instruction unit 132 displays the unlocking code on the display screen of the user terminal 20 by the user's operation on the user terminal 20. The display instruction unit 132 also displays various types of display information generated by the server 14 on the display screen of the user terminal 20 by the user's operation on the user terminal 20.

Operation and Effect of Self-Propelled Delivery Box

In the present embodiment, as shown in FIGS. 2 and 3, the food delivery pallet 16 is provided with the heating chamber 26, the heat retaining chamber 28, the heat retaining chamber 30, and the cooling chamber 32 as the food keeping unit, and the electric bulletin board 24 as a warning unit.

The food keeping unit is provided in the food delivery pallet main body 22, and the arrangement place is provided in accordance with the keeping state of the food to be delivered. Further, the electric bulletin board 24 is provided on the outside of the food delivery pallet main body 22, and calls attention of the outside to the food delivery pallet 16 (food delivery pallet main body 22).

With the above configuration, in the present embodiment, for example, when the food is heated in the heating chamber 26, the electric bulletin board 24 displays that the food is being heated in the food delivery pallet 16. This makes it possible to call attention of people nearby to the food delivery pallet 16 in the present embodiment.

In other words, in the present embodiment, the food delivery pallet 16 can ensure the safety of the people nearby. As described above, the food delivery pallet 16 in the present embodiment displays precautions so that the people nearby can recognize the status of the food delivery pallet 16, and therefore can call attention of the people nearby.

Further, when the electric bulletin board 24 calls attention of the outside to the food delivery pallet 16, the distance between the food delivery pallet 16 and the people near the food delivery pallet 16 may be set to be larger than usual. Accordingly, the food delivery pallet 16 can further ensure safety for the people near the food delivery pallet 16.

In the present embodiment, the electric bulletin board 24 is provided as a warning unit, but the warning unit is not limited to this as long as the warning unit can call attention of the people near the food delivery pallet 16. For example, although not shown, a notification unit for notifying the precautions for the food delivery pallet 16 may be provided and the notification unit may be set so that the precautions are notified to the outside via the notification unit by voice or the like. This notification unit may be used in combination with the electric bulletin board 24, or only the notification unit may be used instead of the electric bulletin board 24.

In the present embodiment, as described above, the food delivery pallet 16 is provided with the heating chamber 26 for heating the food, and the food can be heated in the heating chamber 26. Therefore, the food can be heated while the food delivery pallet 16 travels by itself from the store 12 (see FIG. 1) at which the food is supplied to the users home 18 at which the food is received.

Therefore, in the present embodiment, by performing the heating and cooking, which are normally performed in the store 12, while the food delivery pallet 16 travels by itself, it is possible to save the time required when the food is normally heated in the store 12. Further, in the present embodiment, the heated and cooked pizzas 48, 50 are packed in the decorative boxes 56, 58, so that the packing time can be saved accordingly.

Furthermore, in the present embodiment, by performing the heating and cooking, which are normally performed in the store 12, on the food delivery pallet 16, the space of the store 12 can be reduced. Depending on the time required to reach the users home 18, the food does not necessarily need to be heated in the heating chamber 26, and the heated and cooked pizzas 48, 50 may be placed on the transport belt 42 and only be packed while traveling.

In the above embodiment, the food delivery pallet 16 has been described. However, the present disclosure does not necessarily need to be applied to a delivery pallet but may be applied to a food pallet used for outdoor sales. In this case, although not shown, heat-resistant glass or the like may be used in the food delivery pallet main body 22 so that the inside of the food delivery pallet main body 22 can be seen.

Various processors other than the CPU may execute processes executed by the CPU when the CPU reads the software (program) in the above embodiment. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. Each process in the above embodiment may be executed by one of these various processors, or by a combination of two or more processors of the same type or different types (for example, a combination of FPGAs, a combination of a CPU and an FPGA, and the like). The hardware structure of these various processors is, more specifically, an electric circuit in which circuit elements such as semiconductor elements are combined.

The mode in which the program of the process in the above embodiment is stored (installed) in the ROM or the storage in advance has been described, but the present disclosure is not limited to this. The program may be recorded in a recording medium such as a compact disc read-only memory (CD-ROM), a digital versatile disc read-only memory (DVD-ROM), and a universal serial bus (USB) memory to be provided. The program may be downloaded from an external device via a network.

What is claimed is:

1. A self-propelled food delivery pallet that is able to travel by itself between a supply base at which food is supplied and a receiving base at which the food is received, the self-propelled food delivery pallet comprising:
a food keeping unit provided in a food delivery pallet main body and provided with an arrangement place in accordance with a keeping state of the food to be delivered; and
a warning unit that is provided on an outside of the food delivery pallet main body and that calls attention of an outside to the food delivery pallet main body.

2. The self-propelled food delivery pallet according to claim 1, wherein the warning unit includes a display unit that displays a precaution for the food delivery pallet main body.

3. The self-propelled food delivery pallet according to claim 1, wherein the warning unit includes a notification unit that notifies a precaution for the food delivery pallet main body.

4. The self-propelled food delivery pallet according to claim 1, wherein when the warning unit calls attention of the outside to the food delivery pallet main body, a distance between the food delivery pallet main body and people nearby is set to be larger than usual.

5. The self-propelled food delivery pallet according to claim 1, wherein the food keeping unit includes at least one of a heat retaining chamber for keeping the food warm and a cooling chamber for cooling the food.

6. The self-propelled food delivery pallet according to claim 1, wherein the food keeping unit includes a heating chamber for heating the food.
